(19) United States
(12) Patent Application Publication
(10) Pub. No.: US 2025/0135779 A1
(43) Pub. Date: May 1, 2025

(54) LIQUID DISCHARGE HEAD AND LIQUID DISCHARGE APPARATUS

(71) Applicant: Hiroya TOKITA, Kanagawa (JP)

(72) Inventor: Hiroya TOKITA, Kanagawa (JP)

(21) Appl. No.: 18/835,369

(22) PCT Filed: Jan. 13, 2023
(86) PCT No.: PCT/IB2023/050301

§ 371 Date: Aug. 2, 2024

(30) Foreign Application Priority Data
Feb. 15, 2022 (JP) 2022-021088
Apr. 25, 2022 (JP) 2022-071570

(51) Int. Cl. B41J 2/145; B41J 2/175

(52) U.S. Cl. CPC B41J 2/145; B41J 2/17596

(57) ABSTRACT

A liquid discharge head includes: an array of multiple discharge openings from each of which a liquid is to be discharged onto a recording medium moved relative to the liquid discharge head in a relative movement direction; a liquid channel communicating with each of the multiple discharge openings; and a supply opening configured to supply liquid to the liquid channel, wherein two or more discharge openings of the multiple discharge openings in the array are adjacent to each other in an orthogonal direction orthogonal to the relative movement direction, the array is arrayed in an array direction tilted with respect to the orthogonal direction.

### TECHNICAL FIELD

The present disclosure relates to a liquid discharge head and a liquid discharge apparatus.

### BACKGROUND ART

A liquid discharge head includes multiple discharge openings. When an image is formed on a recording medium, liquid is discharged from an array of such discharge openings so as to sequentially form an image, starting from a portion downstream in a conveyance direction of the recording medium.

In a configuration in which multiple discharge openings are arranged side by side in the same positions in the conveyance direction of the recording medium, however, liquid needs to be discharged through the respective discharge openings forming a discharge opening array with a fixed timing during the formation of an image.

Patent Literature 1 (Japanese Translation of PCT International Application Publication No. JP-T-2020-501889), for instance, discloses an invention in which a moving mechanism capable of adjusting positions of nozzles by rotation or the like of the nozzles is provided on a print head.

### CITATION LIST

### Patent Literature

### [PTL 1]

Japanese Translation of PCT International Application Publication No. JP-T-2020-501889

### SUMMARY OF INVENTION

### Technical Problem

In a configuration in which discharge openings communicate with each other through a common liquid channel, a discharge force to discharge a liquid from the discharge openings decreases due to a reduction in pressure applied to the discharge openings if a shutoff valve that closes the discharge openings is opened to simultaneously discharge the liquid through the discharge openings. In view of the above, the present disclosure is aimed at suppressing the reduction in discharge pressure for liquid discharge through the discharge openings.

### Solution to Problem

In an aspect of this disclosure, a liquid discharge head includes: an array of multiple discharge openings from each of which a liquid is to be discharged onto a recording medium moved relative to the liquid discharge head in a relative movement direction; a liquid channel communicating with each of the multiple discharge openings; and a supply opening configured to supply liquid to the liquid channel, wherein two or more discharge openings of the multiple discharge openings in the array are adjacent to each other in an orthogonal direction orthogonal to the relative movement direction, the array is arrayed in an array direction tilted with respect to the orthogonal direction.

### Advantageous Effects of Invention

According to the present disclosure, the reduction in discharge pressure for liquid discharge through the discharge openings is suppressed.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings

FIGS. 1A and 1B are external perspective views of a liquid discharge head according to an embodiment of the present disclosure.

FIG. 2 is a general cross-sectional view of the liquid discharge head according to the embodiment of the present disclosure.

FIG. 3 is a diagram illustrating an arrangement of a liquid channel and discharge openings according to the embodiment of the present disclosure.

FIG. 4 is a diagram illustrating an arrangement of discharge openings different from the arrangement in the present disclosure.

FIG. 5 is a diagram illustrating another example of the liquid channel.

FIGS. 6A to 6C are diagrams illustrating exemplary arrangements of discharge openings.

FIG. 7 is a diagram illustrating a liquid channel formed with a single channel.

FIGS. 8A and 8B are general views of a schematic configuration of a liquid discharge apparatus.

FIG. 9 is a schematic configuration of an example of a liquid supply device and a drive controller.

FIGS. 10A to 10C illustrate a discharge operation of ink by the shutoff valve, and FIG. 10D illustrates a drive pulse during the discharge operation.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

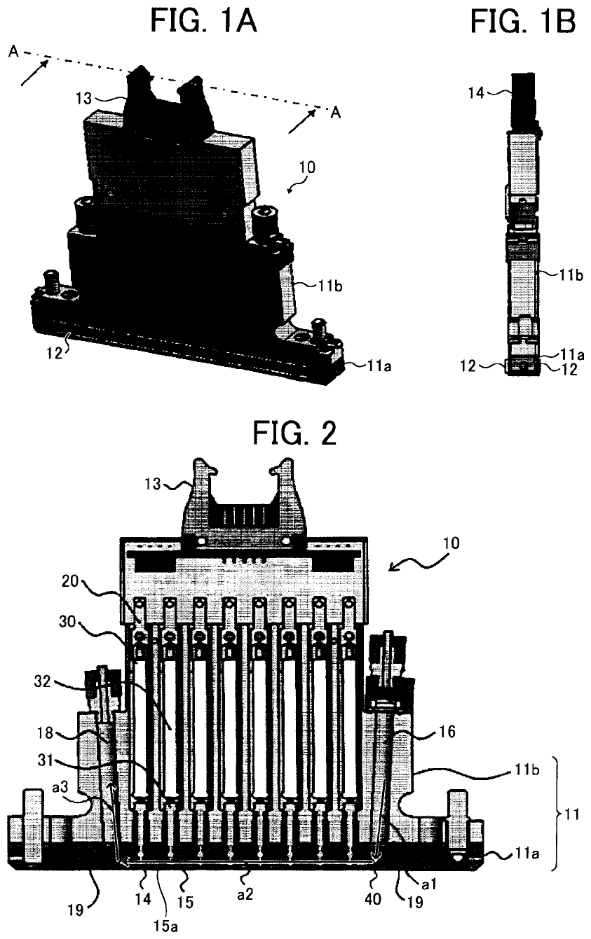

In the following, embodiments of the present disclosure are described with reference to the drawings. FIG. 1 is an external view illustrating a liquid discharge head according to an embodiment of the present disclosure. FIG. 1(a) is a general perspective view of the liquid discharge head, and FIG. 1(b) is a general side view of the liquid discharge head. The liquid discharge head of the present disclosure discharges ink as liquid.

A liquid discharge head 10 includes a first housing 11a as a first case and a second housing 11b as a second case. The second housing 11b is stacked on and bonded to the first housing 11a. The first housing 11a is made of a material with a high thermal conductivity, such as metal, and the second housing 11b is made of a material with a low thermal conductivity, such as a resin. In the description below, the two housings are collectively referred to as a housing 11 as appropriate.

Heaters 12 as heating means are provided on a front face and a back face of the first housing 11a, respectively. The heaters 12 are controllable in temperature, and heat the first housing 11a. In an upper portion of the second housing 11b, a connector 13 for electrical signal communication is provided.

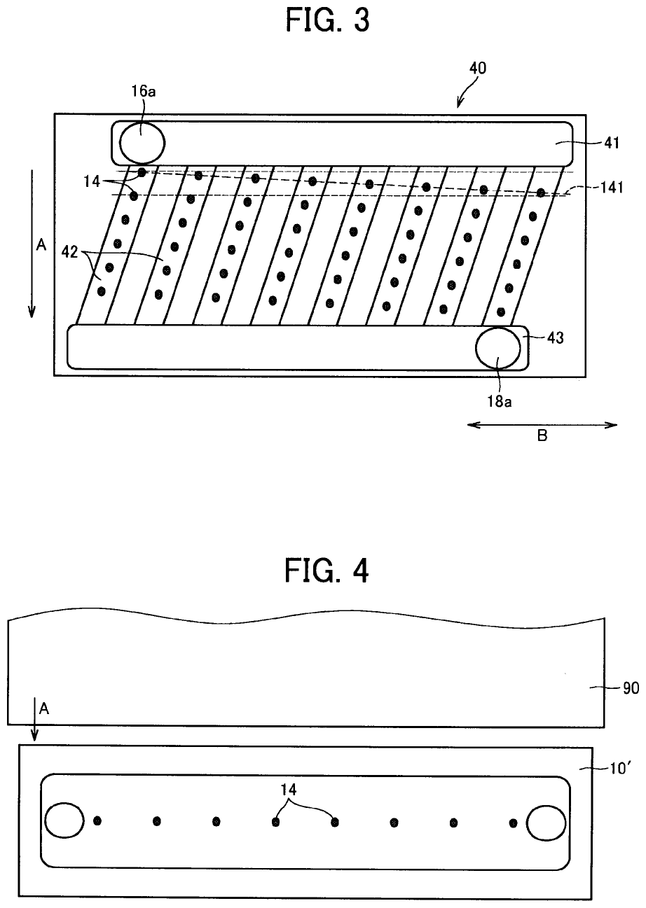

FIG. 2 is a general cross-sectional view of the liquid discharge head 10 according to the embodiment of the present disclosure, illustrating a cross section taken along a line A-A in FIG. 1(a) as viewed in a direction indicated with arrows. The first housing 11a holds a nozzle plate 15 as a plate member. The nozzle plate 15 includes nozzles 14 as discharge openings to discharge liquid. The first housing 11a includes a liquid channel 40 as a liquid supplier. The liquid channel 40 allows ink coming from a supply port 16 side to pass on the nozzle plate 15 to a collection port 18 side.

The second housing 11b includes a supply port 16 and a collection port 18. The supply port 16 and the collection port 18 are coupled to one side and the other side of the liquid channel 40, respectively. Between the supply port 16 and the collection port 18, two or more liquid discharge modules 30 are arranged. The liquid discharge modules 30 discharge ink in the liquid channel 40 through the nozzles 14. In an upper portion of each liquid discharge module 30, a regulation member 20 is provided.

The number of the liquid discharge modules 30 corresponds to the number of the nozzles 14 provided on the first housing 11a, and a configuration in which eight liquid discharge modules 30 are provided correspondingly to eight nozzles 14 arrayed in a row is illustrated in the present example. The nozzles 14 and the liquid discharge modules 30 are not limited in number nor arrayal to the above. For instance, the number of the nozzles 14 and the liquid discharge modules 30 may be one instead of being two or more. The nozzles 14, and the liquid discharge modules 30 as well, may be arrayed not in a row but in multiple rows.

In FIG. 2, a sealing member 19 is provided in a bonding part between the first housing 11a and the second housing 11b. In the present example, an O-ring is used as the sealing member so as to prevent ink from leaking from the bonding part between the first housing 11a and the second housing 11b.

According to the configuration as above, the supply port 16 takes ink put under pressure in from outside, sends the ink in a direction indicated with an arrow a1, and supplies the ink to the liquid channel 40. The liquid channel 40 sends the ink supplied from the supply port 16 in a direction indicated with an arrow a2. The collection port 18 collects, in a direction indicated with an arrow a3, ink not discharged through the nozzles 14 arranged along the liquid channel 40.

The liquid discharge modules 30 each include a shutoff valve 31 disposed on the liquid channel 40 and a piezoelectric element 32 as a driver. The shutoff valves 31 are respectively provided for the nozzles 14 and open and close the corresponding nozzles 14. The piezoelectric element 32 drives the shutoff valve 31. The piezoelectric element 32 elastically operates in a longitudinal direction, that is to say, in a vertical direction in FIG. 2 according to the application of a voltage.

In the configuration as above, if the piezoelectric element 32 operates to move the shutoff valve 31 upward, the nozzle 14, which has been closed by the shutoff valve 31, is opened so as to discharge ink through the nozzle 14. If the piezoelectric element 32 operates to move the shutoff valve 31 downward, a tip of the shutoff valve 31 seals and closes the nozzle 14, so that the ink is no more discharged through the nozzle 14.

Next, the arrangement of the nozzles 14 and the liquid channel 40 is further detailed using FIG. 3. FIG. 3 is a plan view of the nozzles 14 and the liquid channel 40 as viewed from above in FIG. 2.

As illustrated in FIG. 3, ink is supplied to the liquid channel 40 through a supply opening 16a provided on the supply port 16 in FIG. 2.

The liquid channel 40 has a supply side main channel 41, multiple branch channels 42, and a collection side main channel 43. The supply side main channel 41 communicates with the supply opening 16a. The branch channels 42 are channels branched from the supply side main channel 41, and the multiple nozzles 14 are located in the branch channels 42. Each branch channel 42 joins the collection side main channel 43 on a downstream side. The collection side main channel 43 communicates with a collection opening 18a provided on the collection port 18 (see FIG. 2).

The supply side main channel 41 and the collection side main channel 43 extend in a direction orthogonal to a recording medium conveyance direction A. The respective branch channels 42 extend in a direction tilted with respect to the recording medium conveyance direction A.

The recording medium conveyance direction A is a direction in which a recording medium moves with respect to the liquid discharge head during the discharge of liquid by the liquid discharge head, and is also a sub-scanning direction in a liquid discharge head of a serial type. Hereinafter, this direction is also referred to simply as a movement direction, and an upstream side and a downstream side in the movement direction are also referred to simply as an upstream side and a downstream side, respectively. A double-pointed arrow B in FIG. 3 indicates a direction orthogonal to the movement direction and, moreover, orthogonal to a discharge direction of ink as a direction orthogonal to a drawing plane of FIG. 3 (or a direction in which the nozzles 14 extend, namely, the vertical direction in FIG. 2), and the indicated direction is hereinafter also referred to as an orthogonal-to-conveyance direction. The “orthogonal-to-conveyance direction” may be referred simply as “orthogonal direction”. The orthogonal-to-conveyance direction is also a main scanning direction in the liquid discharge head of a serial type. The direction A is not necessarily limited to the direction, in which the recording medium is conveyed, and is a movement direction of the liquid discharge head in a liquid discharge apparatus to be described later that moves the liquid discharge head so as to discharge liquid to the recording medium. In other words, the direction A is a relative movement direction of the liquid discharge head and the recording medium. The direction B is a direction orthogonal to the direction A, which is the relative movement direction of the liquid discharge head and the recording medium, while this direction may also be the relative movement direction of the liquid discharge head and the recording medium, as in the liquid discharge apparatus to be described later.

Along the branch channels 42, the multiple nozzles 14 are provided. In the present disclosure, the nozzles 14 in the branch channels 42 are arranged at equal intervals. In an upper portion of each nozzle 14, the corresponding liquid discharge module 30 (see FIG. 2) is provided.

As illustrated in FIG. 3, ink is supplied through the supply opening 16a when the ink is discharged to the recording medium. A pressure attained by the drive of the liquid discharge module 30 corresponding to the nozzle 14 to discharge the ink allows the ink to be discharged through the nozzle 14.

FIG. 4 illustrates an arrangement of the nozzles 14 that is different from the arrangement in the present disclosure. In a liquid discharge head illustrated in FIG. 4, the nozzles 14 are arrayed in a direction orthogonal to the conveyance direction A. In other words, the respective nozzles 14 are provided in the same positions in the conveyance direction A.

With such arrangement of the nozzles 14, ink is sequentially discharged to a recording medium 90 conveyed from above downward in FIG. 4, starting from a portion on the downstream side in the conveyance direction A of the recording medium 90, so as to form an image. On this occasion, if the ink needs to be discharged through two or more nozzles 14 to the same positions in the conveyance direction A on the recording medium 90, the respective nozzles 14 are to discharge the ink with a fixed timing. The pressure applied to the nozzles 14, however, is reduced as the number of the nozzles 14, which are to discharge the ink at a time, increases. The reason is as follows: The amount and the flow velocity of ink supplied to the liquid channel 40 through the supply opening 16a are substantially uniform irrespective of the number of shutoff valves driven at a time, in which the flow rate and the discharge flow velocity of ink discharged through one nozzle 14 decrease as the sum of cross-sectional areas of the nozzles 14 opened increases. If ink is discharged through the eight nozzles 14 in FIG. 4 at a time, for instance, pressure loss is eight times larger as compared with the case in which ink is only discharged from a single nozzle 14. In a configuration in which individual liquid chambers that the respective nozzles 14 are provided on are arranged in series, in particular, the above problem is conspicuous, and the flow rate and the discharge velocity of ink decrease toward the downstream side.

As described above, the capacity for discharging ink through the respective nozzles 14 deteriorates as the number of the nozzles 14 to discharge ink at a time increases. In contrast, in the present disclosure, positions in the relative movement direction of the respective nozzles 14 are made different from each other so as to shift the timing for discharging ink through the respective nozzles 14 and thus avoid simultaneous discharge, which prevents the above deterioration of ink discharging capacity.

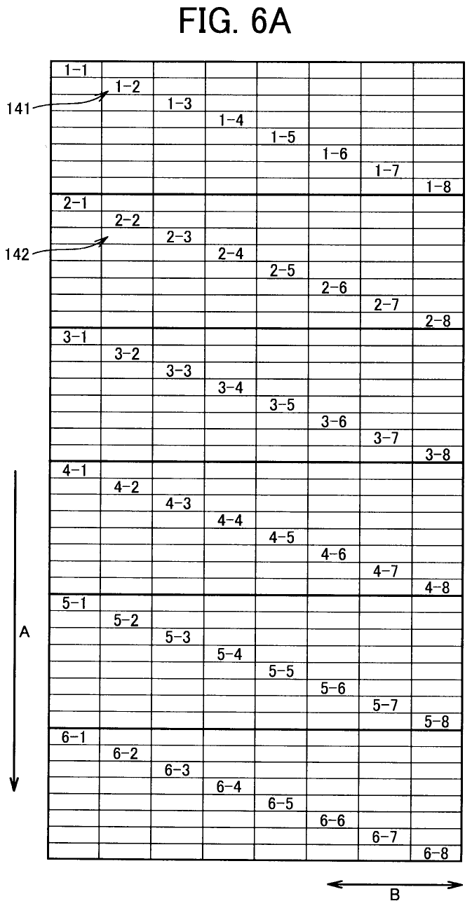

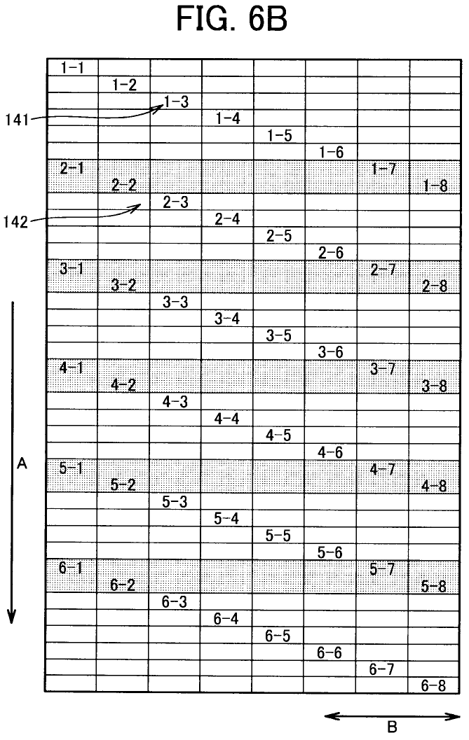

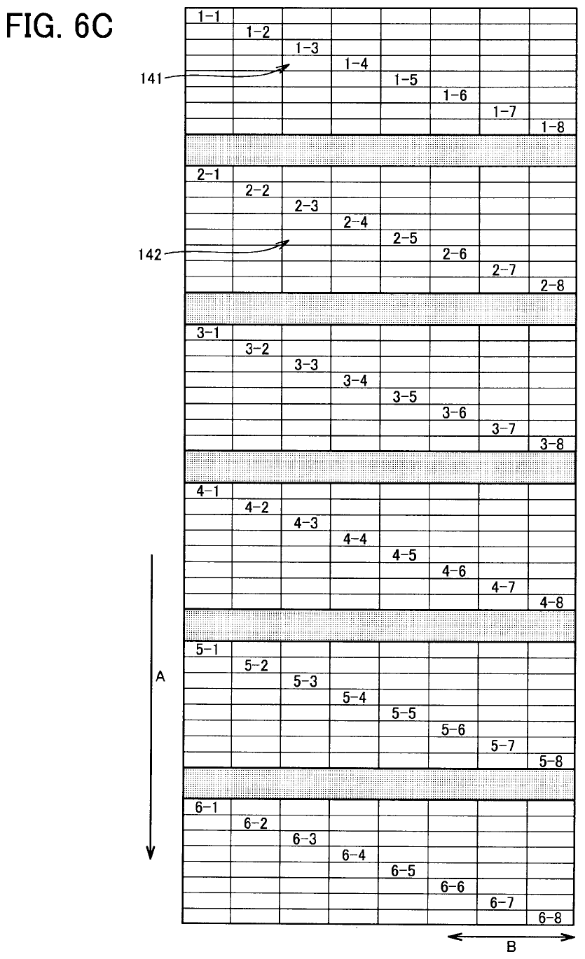

Specifically, a nozzle array 141 in FIG. 3 formed with the nozzles 14 in the respective branch channels 42, which nozzles are arranged closest to the upstream side, has an array direction tilted with respect to the orthogonal-to-conveyance direction B as a direction orthogonal to the conveyance direction A and is as such linearly arranged. In other words, the nozzles 14 forming the nozzle array 141 are different from each other in position in the conveyance direction A, and a nozzle 14 closer to the right in FIG. 3 is arranged closer to the downstream side in the conveyance direction A. The nozzle array 141 is a group of the nozzles 14 formed by two or more nozzles 14 adjacent to each other in the orthogonal-to-conveyance direction B that are arrayed. The two nozzles 14 adjacent to each other in the orthogonal-to-conveyance direction B do not necessarily refer to two nozzles 14 arranged in the same positions in the conveyance direction A but include nozzles arranged in different positions in the conveyance direction A, such as the nozzle 14 indicated with “1-1” and the nozzle 14 indicated with “1-2” in FIG. 6(a). In other words, the nozzle array is a row of the nozzles 14, which among the nozzles 14 substantially arranged in the form of a matrix on a nozzle face as illustrated in FIG. 3 of the present disclosure are arranged in the orthogonal-to-conveyance direction B. The arrangement in the form of a matrix includes an arrangement with a single row in the orthogonal-to-conveyance direction B. Strictly speaking, the arrangement of the nozzles 14 as herein referred to is an arrangement of the nozzles 14 on a nozzle face 15a (see FIG. 2), namely, an arrangement of opening ends on a downstream side in the discharge direction of the nozzles 14.

As described above, the multiple nozzles 14 arrayed in different positions in the orthogonal-to-conveyance direction B are arranged in different positions in the conveyance direction so as to shift the timing for discharging ink to the recording medium through the respective nozzles 14. Consequently, in the configuration in which each of the multiple nozzles 14 fluidically communicates with the common liquid channel 40, the reduction in discharge pressure due to simultaneous discharge of ink through the multiple nozzles 14 is prevented. The position difference in the conveyance direction of the respective nozzles 14 forming the nozzle array 141 is set to a value smaller than a recording resolution in the conveyance direction A of the recording medium or a value that is not an integral multiple of the recording resolution. As a result, the timing for discharging ink is shifted as stated above.

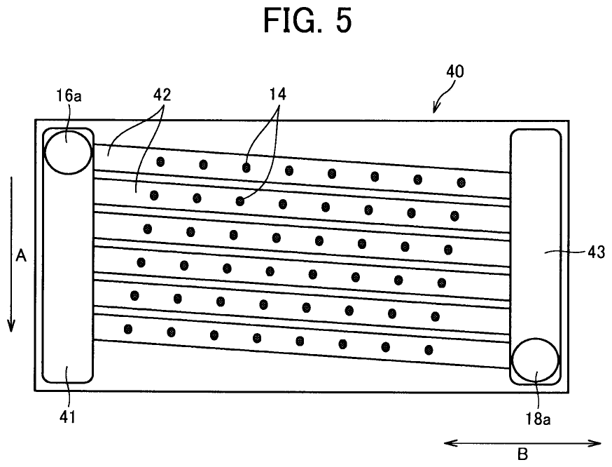

Next, a modification on the liquid channel 40 is described using FIG. 5.

In a liquid channel 40 illustrated in FIG. 5, a supply side main channel 41 and a collection side main channel 43 extend in the conveyance direction A, and branch channels 42 each extend in a direction tilted with respect to the orthogonal-to-conveyance direction B. In the present embodiment, the nozzle array 141 or the like is formed with the nozzles 14, which are arranged in the same branch channel 42. The nozzle array 141 as such has an array direction tilted with respect to the orthogonal-to-conveyance direction B. In other words, the nozzles 14 forming the nozzle array 141 are different from each other in position in the conveyance direction A, and, in each branch channel 42, a nozzle 14 closer to a downstream side of the relevant branch channel is arranged closer to the downstream side in the conveyance direction A (a lower side in FIG. 5).

Also in the present embodiment, the timing for discharging ink through the respective nozzles 14 forming the nozzle array is shifted. As a result, the deterioration of the capacity for discharging ink through the nozzles 14 is prevented.

The liquid channel 40 is formed with the supply side main channel 41, the collection side main channel 43, and the respective branch channels 42 in the embodiments in FIGS. 3 and 5, which allows the nozzles 14 to be arranged in the orthogonal-to-conveyance direction B at a high density, and achieves space saving of the liquid discharge head.

Next, a modification on the arrangement of the nozzles 14 is described using FIGS. 6(a) through 6(c). In FIG. 6, the arrangement of the respective nozzles 14 is illustrated with numerical symbols such as “1-1” corresponding to the nozzles 14, respectively. In FIG. 6, the respective nozzles 14, which form the same first nozzle array 141 (see FIG. 5), are expressed by “1-1” through “1-8”. Similarly, the arrangement of the respective nozzles 14, which form another nozzle array, is illustrated with “2-1” through “2-8”, or the like.

In FIG. 6(a), the nozzles 14 expressed by “1-1” through “6-8” are all arranged in different positions in the conveyance direction A. Such arrangement allows the maximum avoidance of the simultaneous discharge of ink with the multiple nozzles 14, and is especially preferable. In FIG. 6(a), in particular, all the nozzles 14 are arranged at equal intervals in the conveyance direction A. As a result, discharge characteristics for the respective nozzles 14 are made more uniform, which is favorable. It is most preferable to arrange all the nozzles 14 at equal intervals as in FIG. 6(a), while the nozzles may partially be arranged at equal intervals.

In FIG. 6(a), the position difference of the respective nozzles 14 in the same nozzle array is set smaller than a distance between the nozzles 14 arranged in the conveyance direction A. Specifically, the respective nozzles 14 forming the nozzle array 141 are arranged on the upstream side in the conveyance direction A of the nozzle 14 expressed by “2-1”, and the position difference in the conveyance direction A of the respective nozzles 14 forming the nozzle array 141 is set smaller than the distance between the nozzle 14 expressed by “1-1” and the nozzle 14 expressed by “2-1”, which are arranged in the conveyance direction A. As a result, the nozzles 14 are made different from each other in position in the conveyance direction A, and the simultaneous discharge through the respective nozzles 14 is avoided.

It is not necessarily indispensable that all the nozzles 14 are in different positions in the conveyance direction A. In an arrangement illustrated in FIG. 6(b), for instance, the last two nozzles 14 in each nozzle array are the same in position in the conveyance direction A as the first two nozzles 14 in a nozzle array adjacent to the relevant nozzle array on the downstream side. As an example, the last two nozzles “1-7” and “1-8” in a first nozzle array 141 are arranged in positions in the conveyance direction A that are the same as the positions in the conveyance direction A of the first two nozzles “2-1” and “2-2” in an adjacent, second nozzle array 142, respectively. Also in the present embodiment, simultaneous discharge through part of the nozzles 14 is avoided, so that the reduction in discharge pressure for discharge through the nozzles 14 is suppressed. In addition, the liquid discharge head is downsized as compared with the case of the arrangement of the nozzles 14 in FIG. 6(a).

As illustrated in FIG. 6(c), the distance between the nozzles 14 arranged in the conveyance direction A may be made uneven. In FIG. 6(c), a wide space is left between the respective nozzle arrays and, in consequence, the distance in the conveyance direction A between the respective nozzles 14 is uneven. As a result, the timing for discharging ink through the respective nozzles 14 is made easy to shift.

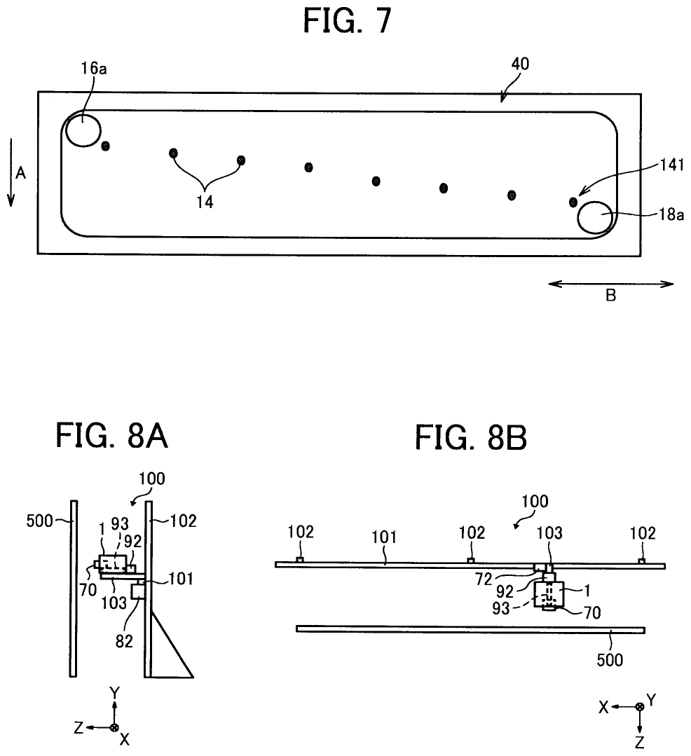

A fluid channel 40 illustrated in FIG. 7 as an embodiment different from the above embodiments is not branched into main channels and branch channels but is formed with a single channel. In this fluid channel 40, the first nozzle array 141 (single nozzle array) is formed with the nozzles 14 arranged in a row. The nozzle array 141 has an array direction tilted with respect to the orthogonal-to-conveyance direction B. As a result, the timing for discharging ink to the recording medium through the respective nozzles 14 is shifted. Consequently, in the configuration in which each of the multiple nozzles 14 fluidically communicates with the common liquid channel 40, the reduction in discharge pressure due to simultaneous discharge of ink through the multiple nozzles 14 is prevented.

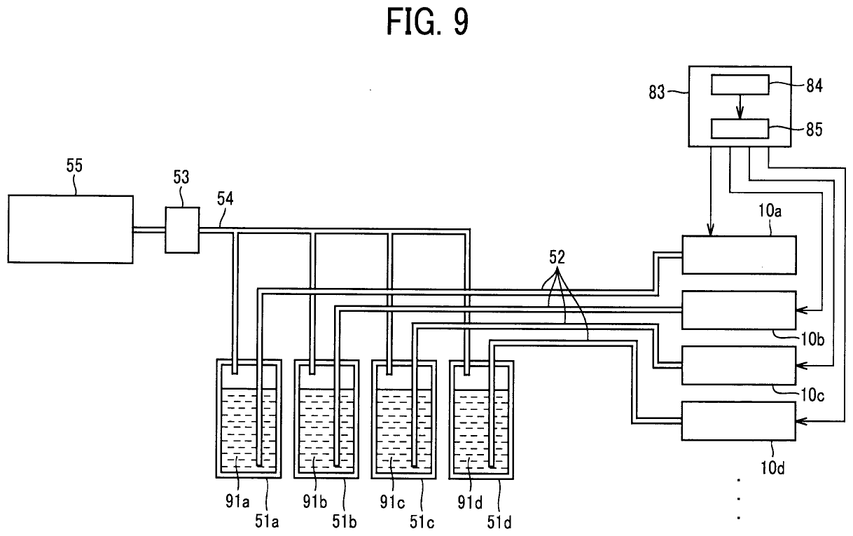

Next, a liquid supply unit that supplies ink as liquid to the liquid discharge head and a drive controller that controls ink discharge operation of the liquid discharge head is described below with reference to FIG. 9. FIG. 9 is a schematic circuit diagram of a liquid supply unit and a drive controller according to the first embodiment.

The liquid discharge apparatus 100 includes four liquid discharge heads 10a to 10d as a liquid discharge head 10 and tanks 51a to 51d as closed containers that accommodate inks 30a to 30d respectively discharged from the liquid discharge heads 10a to 10d. In the following description, these inks are collectively referred to as the ink 91. The tanks 51a to 51d may be collectively referred to as a tank 51.

The tanks 51 and supply ports (supply ports 16 in FIG. 2) of the liquid discharge head 10 are respectively connected to each other via tubes 52. The tanks 51 are coupled to a compressor 55 via a pipe 54 including an air regulator 53. The compressor 55 supplies pressurized air to the tanks 51. Thus, the ink 91 is discharged from the nozzle 14 when the needle valve 331 as described above is opened since the ink 91 in the liquid discharge head 10 is in a pressurized state. The pipe 54 including the compressor 55 and the air regulator 53, the tanks 51, and the tubes 52 collectively form an example of a liquid supply unit that pressurizes and supplies the ink 91 to the liquid discharge head 10.

The ink collected (recovered) from the collection port 18 in FIG. 2 may be returned to the tank 51 and circulated between the tank 51 and the liquid discharge head 10 by a pump or the like.

The drive controller 83 includes a waveform generation circuit 84 serving as a drive pulse generator and an amplification circuit 85. The waveform generating circuit 84 generates a drive pulse waveform as described below. The amplification circuit 85 amplifies the voltage value to a prescribed value. Then, the amplified voltage is applied to the piezoelectric element 32. The drive controller 83 applies the voltage to the piezoelectric element 32 to control an opening and closing of the shutoff valve 31 and controls the ink discharge operation from the liquid discharge head 10. However, when the waveform generating circuit 84 can apply a voltage of a sufficient value, the amplification circuit 85 may be omitted from the drive controller 83.

The waveform generation circuit 84 generates a drive pulse that is a waveform of a voltage, applied to the piezoelectric element 32, changing over time. The waveform generating circuit 84 receives print data from an external personal computer (PC) or a microcomputer in the liquid discharge apparatus 100, and generates a drive pulse based on this input data. The waveform generation circuit 84 can change the voltage applied to the piezoelectric element 32 and generate multiple drive pulses. As described above, the waveform generation circuit 84 generates the drive pulse so that the piezoelectric element 32 expands and contracts in accordance with the drive pulse to open and close the shutoff valve 31.

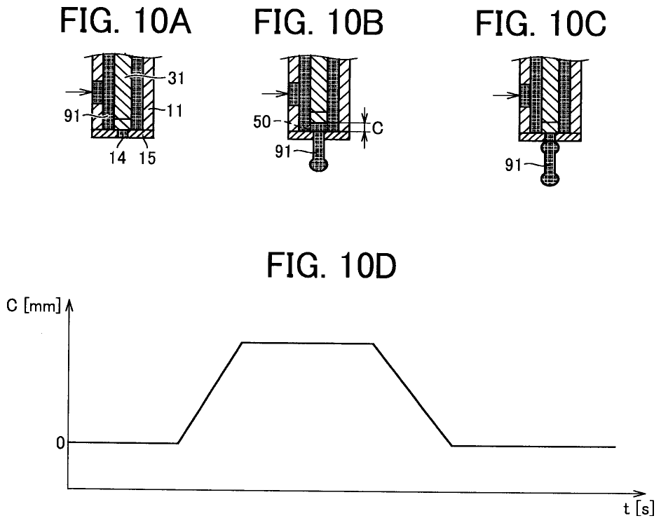

Next, a state in which the drive controller 83 applies a voltage to the piezoelectric element 32 to drive the shutoff valve 31 is described below with reference to FIG. 10. FIGS. 10A to 10C are schematic cross sectional views of the shutoff valve 31 illustrating states of an opening and closing operation of the shutoff valve 31. FIG. 10D illustrates a displacement amount of the shutoff valve 31 at the time of the opening and closing operation of the shutoff valve 31. A horizontal axis represents a time “t” (s), and a vertical axis represents a displacement amount “C” (mm) of the shutoff valve 31. The displacement amount of the shutoff valve 31 indicates an amount of movement of the shutoff valve 31 that moves from a position “0” at which the shutoff valve 31 contacts the nozzle plate 15 to close the nozzle 14 toward an opening direction. The opening direction corresponds to an upper direction in FIG. 10A.

The drive controller 83 applies a drive pulse to the piezoelectric element 32 to expand and contract the piezoelectric element 32 to drive the shutoff valve 31. The drive pulse is a voltage pulse. The drive pulse is proportional to the displacement of the shutoff valve 31. That is, the drive pulse, formed by the drive controller 83, with respect to the time “t” forms a waveform having the same shape as a transition of the displacement amount of the shutoff valve 31 with respect to the changing over the time “t” in FIG. 10D. Therefore, it is assumed that the waveform of the displacement amount C illustrated in FIG. 10D is the waveform of the drive pulse (is equal to the waveform of the drive pulse) in the following description.

In a state in which the voltage applied to the piezoelectric elements 32 is 0 V, the piezoelectric elements 32 expands and the shutoff valve 31 comes into contact with the nozzle plate 15 as illustrated in FIG. 10A. As a result, the shutoff valve 31 closes the nozzle 14. The voltage is set to 0 V when the nozzle 14 is closed in this embodiment. However, a voltage other than the 0 V may be used as long as the voltage is smaller than a predetermined voltage described below.

The piezoelectric element 32 contracts by the voltage applied to the piezoelectric element 32. As illustrated in FIG. 10B, the shutoff valve 31 moves upward in FIG. 10B, and a gap region 50 is formed between the shutoff valve 31 and the nozzle plate 15. Then, the shutoff valve 31 comes into contact with the nozzle plate 15 again to close the nozzle 14 by stopping the application of the voltage to the piezoelectric element 32 or reducing the voltage applied to the piezoelectric element 32 as illustrated in FIG. 10C.

When the nozzle 14 is opened, the ink 91 is pressurized by the compressor 55 (see FIG. 9). Therefore, the ink is discharged by the pressure applied to the ink 91 by the compressor 55 from the nozzle 14 opened as illustrated in FIG. 10B. Further, the ink 91 in the gap region 50 is pressurized and pushed out from the nozzle 14 during a process of closing the shutoff valve 31 as illustrated in FIG. 10C.

The drive controller 83 according to the present embodiment can individually control the piezoelectric elements 32 corresponding to nozzles 14 in the liquid discharge head 10 to individually control the timing at which the liquid is discharged from each nozzle 14. The piezoelectric elements 32 may be configured to contract when a voltage applied to the piezoelectric elements 32 is set to 0V and expand when a voltage more than 0V is applied to the piezoelectric elements 32.

Next, a liquid discharge apparatus including the liquid discharge head 10 as described above is described.

FIG. 8 is a general view of a schematic configuration of a liquid discharge apparatus 100. FIG. 8(a) is a side view of the liquid discharge apparatus, and FIG. 8(b) is a plan view of the liquid discharge apparatus. The liquid discharge apparatus 100 is installed opposite to a liquid application target 500 as a recording medium. The liquid discharge apparatus 100 includes an x-axis rail 101, a y-axis rail 102 intersecting the x-axis rail 101, and a z-axis rail 103 intersecting the x-axis rail 101 and the y-axis rail 102. In the present disclosure, in particular, the rails (x-axis rail 101, y-axis rail 102, and z-axis rail 103) extend in directions orthogonal to one another, respectively.

The y-axis rail 102 holds the x-axis rail 101 so that the x-axis rail 101 may be movable in a y-axis direction. The x-axis rail 101 hold the z-axis rail 103 so that the z-axis rail 103 may be movable in an x-axis direction. The z-axis rail 103 holds a carriage 1 so that the carriage 1 may be movable in a z-axis direction.

The liquid discharge apparatus 100 includes a first Z-direction driver 92 to move the carriage 1 in the z-axis direction along the z-axis rail 103, and an X-direction driver 72 to move the z-axis rail 103 in the x-axis direction along the x-axis rail 101. The liquid discharge apparatus 100 also includes a Y-direction driver 82 to move the x-axis rail 101 in the y-axis direction along the y-axis rail 102. In addition, the liquid discharge apparatus 100 includes a second Z-direction driver 93 to move a head holder 70 in the z-axis direction with respect to the carriage 1. The X-direction driver 72, the Y-direction driver 82, and the Z-direction driver 92 are moving mechanisms that relatively move the liquid discharge head 10 with respect to the liquid application target 500.

The liquid discharge head as described above is fitted to the head holder 70 so that the nozzles 14 (see FIG. 2) of the liquid discharge head 10 may be opposite to the liquid application target 500. The liquid discharge apparatus 100 having such configuration discharges ink as an example of a liquid from the liquid discharge head 10 attached to the head holder 70 toward the liquid application target 500 while moving the carriage 1 in the x-axis, y-axis, and z-axis directions by the moving mechanism including the X-direction driver 72, the Y-direction driver 82, and the Z-direction driver 92 to draw an image on the liquid application target 500.

For example, the drive controller 83 causes the liquid discharge head 10 to discharge the ink from each nozzle 14 by shifting a timing of the discharge operation by the position difference in the direction A of each nozzle 14 of each nozzle array 141 while the moving mechanism moves the liquid discharge head with respect to the liquid application target 500 in the direction A illustrated in FIG. 3 at the speed V. Thus, a row of raster line extending in a direction of arrow B can be formed on the liquid application target 500. Accordingly, the liquid discharge apparatus 100 can form the raster line while reducing a decrease in the discharge pressure of the ink from each nozzle 14. The drive controller 83 cause the liquid discharge head 10 to discharge an ink from a certain nozzle 14 at a timing shifted by a time obtained by dividing the position difference in the direction A with respect to the adjacent nozzle 14 by the speed V. The drive controller 83 sequentially forms the raster lines at intervals corresponding to a recording resolution in the direction A to form a solid image on the liquid application target 500. Accordingly, the liquid discharge apparatus 100 (image forming apparatus) can form a solid image while reducing a decrease in the discharge pressure of the ink from each nozzle 14.

The liquid application target 500 is a body of an automobile or of an aircraft, for instance. The liquid discharge apparatus 100 may form an image in an optional form, such as an image of a character or a photograph, or form an even image, that is to say, perform painting on the liquid application target 500. Alternatively, the position of the carriage 1 including the liquid discharge head 10 may be fixed, and the moving mechanism may move the liquid application target 500 with respect to the carriage 1. The moving mechanism may have a robot arm or the like that supports the carriage 1 and moves the carriage 1 in the X direction, the Y direction, and the Z direction instead of the moving mechanism separately including the X-direction driver 72, the Y-direction driver 82, and the Z-direction driver 92.

The embodiments of the present disclosure have been described above, while the present disclosure is not limited to the above embodiments, and it is a matter of course that various modifications can be made without departing from the gist of the present disclosure.

“Liquid” includes not only ink but a paint.

In the present application, the “liquid discharge apparatus” is an apparatus that includes a liquid discharge head and drives the liquid discharge head so as to discharge liquid. Examples of the liquid discharge apparatus include not only an apparatus to discharge liquid to an object in which the liquid is adherable but an apparatus to discharge liquid into a gas or liquid.

The “liquid discharge apparatus” can include a means concerning the feed, conveyance or ejection of an object in which liquid is adherable, a preprocessing device, a postprocessing device, and the like.

Thus, the “liquid discharge apparatus” is exemplified by an image forming apparatus to discharge ink so as to form an image on a sheet, and a stereo-modeling apparatus (three-dimensional modeling apparatus) to discharge a modeling liquid to a powder bed obtained by forming powder into layered stuff, in order to produce a stereo-modeled product (three-dimensionally modeled product).

The “liquid discharge apparatus” is not limited to an apparatus that allows a meaningful image of a character, a figure or the like to be visualized with the liquid as discharged. An exemplary liquid discharge apparatus may form a pattern that has no meaning in itself or a three-dimensional image.

The above-mentioned “object in which liquid is adherable” includes the recording medium as above, and refers to an object in which liquid is adherable at least temporarily, with examples of such object including an object that the adhered liquid is firmly fixed to and an object that the adhered liquid permeates. Specific examples include a recording material, such as a sheet, a recording paper, a recording sheet, a film, and cloth, an electronic component, such as an electronic board and a piezoelectric element, and such media as a powder bed (powder layer), an organ model, and a cell for examination, and any such objects are included unless the object in which liquid is adherable is particularly limited.

The “object in which liquid is adherable” may be made of such a material as paper, thread, fiber, cloth, leather, metal, plastics, glass, wood or ceramics, as long as liquid is adherable to the material even temporarily.

The “liquid discharge apparatus” may be an apparatus that relatively moves the liquid discharge head and the object in which liquid is adherable, to which apparatus the liquid discharge apparatus is not limited. Specifically, the liquid discharge apparatus may also be a serial type apparatus that moves the liquid discharge head or a line type apparatus that does not move the liquid discharge head.

The “liquid discharge apparatus” is further exemplified by a treatment liquid application apparatus to discharge a treatment liquid to a sheet in order to apply the treatment liquid onto a surface of the sheet for the purpose of surface modification of the sheet or other purpose, and a jet granulation apparatus to inject, through a nozzle, a composition liquid prepared by dispersing raw materials into a solution, so as to form particulates of the raw materials.

In the present application, such terms as image forming, recording, printing, imaging, print making, and modeling are assumed as synonymous with one another.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The liquid discharge head 10 according to the present embodiment may have following embodiments.

### Aspect 1

A liquid discharge head includes: multiple discharge openings configured to discharge liquid; a liquid channel communicating with each of the multiple discharge openings; a supply opening configured to supply liquid to the liquid channel; and a discharge opening array formed with two or more discharge openings adjacent to each other in an orthogonal direction orthogonal to a relative movement direction of the liquid discharge head and a recording medium, the discharge opening array is arrayed in an array direction tilted with respect to the orthogonal direction orthogonal to the relative movement direction of the liquid discharge head and the recording medium.

### Aspect 2

In the liquid discharge head according to aspect 1, all the multiple discharge openings are different in position in the relative movement direction.

### Aspect 3

In the liquid discharge head according to aspect 1 or 2, the multiple discharge openings are arranged at equal intervals in the relative movement direction.

### Aspect 4

In the liquid discharge head according to aspect 3, all the multiple discharge openings are arranged at equal intervals in the relative movement direction.

### Aspect 5

In the liquid discharge head according to aspect 1, the discharge opening array includes a first discharge opening array and a second discharge opening array adjacent to the first discharge opening array on one side (downstream side in the direction A in FIG. 3) in the relative movement direction of the first discharge opening array. A first discharge opening in the first discharge opening array that is arranged closest to the one side in the relative movement direction is disposed closer to another side (upstream side in the direction A in FIG. 3) in the relative movement direction than a second discharge opening in the second discharge opening array that is arranged closest to said another side (upstream side in the direction A in FIG. 3) in the relative movement direction.

### Aspect 6

In the liquid discharge head according to any one of aspects 1 to 5, the liquid channel includes: a main channel communicating with the supply opening; and multiple branch channels bifurcated from the main channel and communicating with the multiple discharge openings.

### Aspect 7

The liquid discharge head according to any one of aspects 1 to 6, further includes: multiple shutoff valves in the liquid channel, the multiple shutoff valves configured to respectively open and close the multiple discharge opening to discharge the liquid from the multiple shutoff valves opened.

### Aspect 8

A liquid discharge apparatus includes: the liquid discharge head according to any one of aspect s 1 through 7; and a moving mechanism configured to relatively move one of the liquid discharge head or a recording medium.

### Aspect 9

In the liquid discharge apparatus according to aspect 8, the moving mechanism moves the liquid discharge head relative to the recording medium; and a timing for discharging ink to the recording medium through each of the multiple discharge openings forming the discharge opening array is shifted for a position difference of each of the multiple discharge openings in the relative movement direction.

This patent application is based on and claims priority to Japanese Patent Application No. 2022-021088, filed on Feb. 15, 2022, in the Japan Patent Office, and Japanese Patent Application No. 2022-071570, filed on Apr. 25, 2022, in the Japan Patent Office, the entire disclosure of which is hereby incorporated by reference herein.

### Reference Signs List

10 liquid discharge head
14 nozzle (discharge opening)
141 nozzle array (discharge opening array)
15 nozzle plate
15a nozzle face
16a supply opening
30 liquid discharge module
40 liquid channel
41 supply side main channel (main channel)
42 branch channel
43 collection side main channel
A recording medium conveyance direction (relative movement direction of the liquid discharge head and the recording medium)
B orthogonal-to-conveyance direction (direction orthogonal to the relative movement direction of the liquid discharge head and the recording medium)

1. A liquid discharge head comprising:
an array of multiple discharge openings from each of which a liquid is to be discharged onto a recording medium moved relative to the liquid discharge head in a relative movement direction;
a liquid channel communicating with each of the multiple discharge openings; and
a supply opening to supply liquid to the liquid channel,
wherein:
two or more discharge openings of the multiple discharge openings in the array are adjacent to each other in an orthogonal direction orthogonal to the relative movement direction, and
the array is arrayed in an array direction tilted with respect to the orthogonal direction.

2. The liquid discharge head according to claim 1, wherein:
the multiple discharge openings are different in position in the relative movement direction.

3. The liquid discharge head according to claim 1 or 2, wherein:
the multiple discharge openings are arranged at equal intervals in the relative movement direction.

4. The liquid discharge head according to claim 3, wherein:
all the multiple discharge openings are arranged at the equal intervals in the relative movement direction.

5. The liquid discharge head according to claim 1, wherein the array includes:
a first array; and
a second array adjacent to and downstream of the first array in the relative movement direction, and
wherein a first discharge opening in the first array disposed at the most downstream in the relative movement direction is disposed upstream, in the relative movement direction, of a second discharge opening in the second array disposed at the most upstream in the relative movement direction.

6. The liquid discharge head according to claim 1, wherein the liquid channel includes:
a main channel communicating with the supply opening; and
multiple branch channels bifurcated from the main channel and communicating with the multiple discharge openings.

7. The liquid discharge head according to claim 1, further comprising:
multiple shutoff valves in the liquid channel, the multiple shutoff valves to respectively open and close the multiple discharge openings to discharge the liquid from the multiple discharge openings respectively opened by the multiple shutoff valves.

8. A liquid discharge apparatus comprising:
the liquid discharge head according to claim 1; and
a driver to move the liquid discharge head relative to the recording medium.

9. The liquid discharge apparatus according to claim 8, wherein:
a timing for discharging ink to the recording medium through each of the multiple discharge openings is shifted for a position difference of each of the multiple discharge openings in the relative movement direction while the moving mechanism moves the liquid discharge head relative to the recording medium.
